(19) United States
(12) Patent Application Publication
(10) Pub. No.: US 2007/0272901 A1
(43) Pub. Date: Nov. 29, 2007

(54) Poly-vinylpyrrolidone electrospun composites and Bio-composite sensing materials

(76) Inventor: Pelagia-Irene Gouma, Port Jefferson, NY (US)

Correspondence Address: DILWORTH & BARRESE, LLP, 333 EARLE OVINGTON BLVD., SUITE 702, UNIONDALE, NY, 11553, US

(21) Appl. No.: 11/634,591

(22) Filed: Dec. 6, 2006

Related U.S. Application Data
(60) Provisional application No. 60/748,925, filed on Dec. 9, 2005.

(51) Int. Cl. H01B 1/12

(52) U.S. Cl. 252/500

(57) ABSTRACT

The present invention provides biosensing material comprising polyaniline (PANI)/poly-vinyl-pyrrolidine (PVP) nanocomposite fibers and polyaniline (PANI)/poly-vinyl-pyrrolidine (PVP) nanocomposite fibers and urease. The present invention also provides an electrospinning process for producing the biosensors of the present invention. If desired, the PANI/PVP/enzyme may be deposited on alumina substrates having gold interdigitated contacts, alumina substrates having heaters deposited thereon, and/or aluminum foil.

### CROSS REFERENCE TO RELATED APPLICATION

This application claims priority to a provisional application filed in the United States Patent and Trademark Office on Dec. 9, 2005 and assigned Ser. No. 60/748,925, the contents of which are incorporated herein in its entirety by reference.

### FIELD OF THE INVENTION

The present invention relates to biosensing materials comprising polyaniline (PANI)/poly-vinyl-pyrrolidine (PVP) nanocomposite fibers, polyaniline (PANI)/poly-vinyl-pyrrolidine (PVP) nanocomposite fibers and urease, and an electrospinning process for producing the same.

### BACKGROUND OF THE INVENTION

Enzymes are nature's most specific and selective catalysts and many of them have been identified as precise bio-recognition molecules applicable in the sensing field. Enzymes have been known since the early 1960's to be useful tools for detecting the presence of chemical species. See Rogers, K. R., (1995), Biosensors Bioelectronics, 10: 533. Biosensors have been used in the determination of concentrations of various analytes in fluids for more than three decades. Biosensors can be defined as a device that converts biological signal into an electrical output with the detection mechanism utilizing the biological system directly. In addition, certain chemicals that are not classified as enzymes can also be used to detect small concentrations of specific chemicals and can be used in the sensing filed. One example of this type of chemical is polyaniline (PANI), which can be used to detect small concentrations of NO₂.

One way that polymers such as polyaniline (PANI) detect analytes is by the electroactivity of these conducting polymers when it comes in contact with a specific analyte. The electroactivity of conducting polymers have been extensively studied for use in chemical and biological sensing applications [1-3]. The quality and stability of PANI has been evaluated by many researchers under various processing mechanisms and environmental conditions. There has been and continues to be much research focused on understanding the charge transfer nature of PANI and the requirements of the polymer for operation in various environments: humid air, dry air, under different gas atmospheres, and biological. The details of the charge transport mechanisms for a conducting polymer in its metallic state as a function of temperature has also been studied. Some researches correlate the charge transport mechanism of PANI to reactions between anions in the doped polymer and protons from water or humidity localized on the film's surface. [5-9].

Polymer blends of PANI with insulating polymers such as poly-vinyl-pyrrolidine (PVP) have also been studied for their effectiveness as electron transports [12]. Inherently PVP is a steric stabilizer [13] and co-dopant [14] for PANI particles yielding a superior matrix for ion exchange in sensing experimentation. PVP has been acclaimed for its effectiveness in dispersion of PANI particles [14,15] and dictation of particle dimensions.

Therefore what is needed is a biosensing material that can use the characteristics of electrospun PVP-PANI matrix and combine it with enzymes so as to produce an enzymatically active sensor with enhanced selectivity and activity.

Accordingly one objective of the present invention is to provide a biosensing material comprising polyaniline (PANI)/poly-vinyl-pyrrolidine (PVP) nanocomposite fibers wherein the polyaniline (PANI)/poly-vinyl-pyrrolidine (PVP) nanocomposite fibers have enhanced activity to gaseous analytes.

Another objective of the present invention is to provide a biosensing material comprising polyaniline (PANI)/poly-vinyl-pyrrolidine (PVP) nanocomposite fibers and urease wherein the biosensing material has enhanced activity to gaseous analytes as well as enhanced enzymatic activity.

Still another object of the present invention is to provide an electrospinning process for producing the biosensing material of the present invention.

Still yet another objective of the present invention is to provide an urea biosensing application that utilizes the high surface area to volume ratio produced by the electrospinning process of the present invention and has enhanced activity to gaseous analytes.

Embodiments achieving these as well as other objectives are further described below and meet the needs of the present market.

### BRIEF DESCRIPTION OF THE DRAWINGS

FIG. 1 is a graphical representation showing a 20% wt./volume LEB-PANI composite response to NO₂ with relative humidity at 40% and 25% and temperature constant at 20° C.

FIG. 2 is a graphical representation showing a 20% wt./volume LEB-PANI composite response to NO₂ with relative humidity at 40% and 25% and temperature constant at 20° C.

FIG. 3 is a SEM of 80% wt./vol PANI-PVP with 1 ml of 0.13 g Urease (in PBS buffer solution) film prepared by electrospinning.

FIG. 4 is a SEM of 20% LEB-PANI 80% PVP.

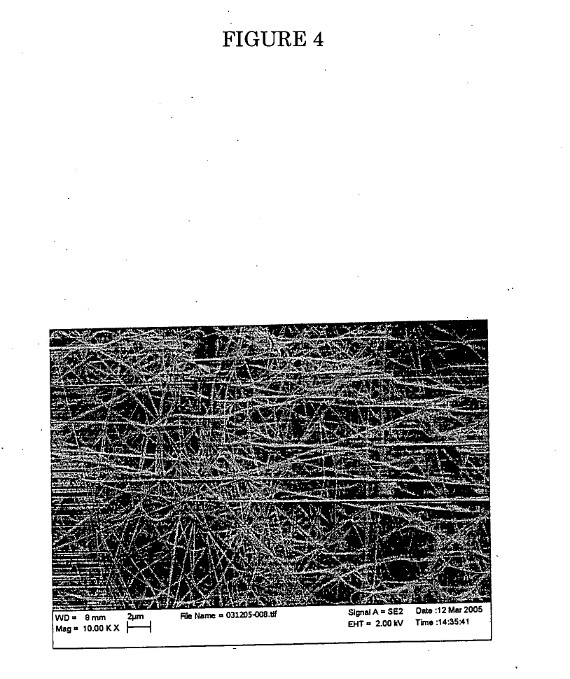

FIG. 5 is a graphical representation showing the sensitivity of Electrospun film at 20% RH.

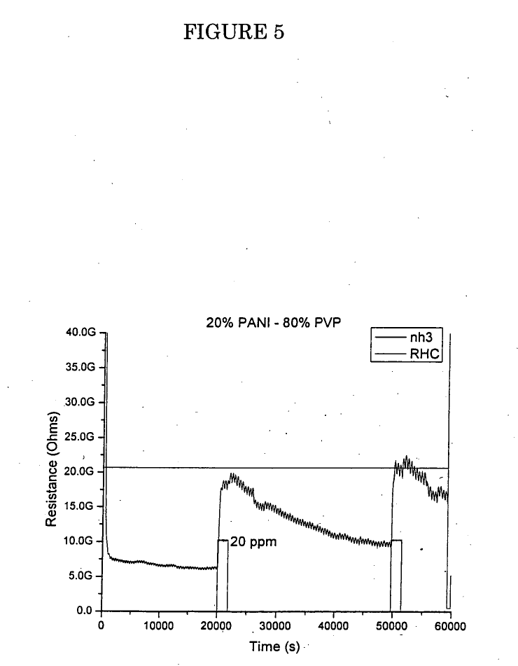

### SUMMARY OF THE INVENTION

The present invention is directed to a biosensing material comprising polyaniline (PANI)/poly-vinyl-pyrrolidine (PVP) nanocomposite fibers wherein the polyaniline (PANI)/poly-vinyl-pyrrolidine (PVP) nanocomposite fibers retain activity to gaseous analytes. The biosensing material may further comprise urease or another enzyme wherein the enzyme retains enzymatic activity. The biosensing material of the present invention may be produced by an electrospinning process.

In one embodiment of the invention the biosensing material may be deposited onto a conductive material such as alumina substrates having gold interdigitated contacts, alumina substrates having heaters deposited thereon, or aluminum foil.

Another embodiment of the invention is directed to a method of producing a biosensor material of the present invention comprising injecting a solution that comprises PVP/PANI and urease under the influence of an electric field wherein the build-up of electrostatic charges on a surface of a liquid droplet of the solution induces the formation of a jet. Once formed, the jet is stretched to form at least one continuous fiber. These fibers are collected on a conductive surface to form a film wherein the polyaniline (PANI) retains its activity to gaseous analytes and the urease enzyme retains its activity to urea.

Still yet other embodiment of the present invention includes methods using the biosensing material of the present invention to provide peritoneal dialysis, hemodialysis, removal of urea from alcoholic beverages, analysis of urea concentration in a solution, a means for forming ammonia from urea, a means for forming carbon dioxide from urea and a means to treat wastewater among other pollutants. These as well as other embodiments are further described below.

### DETAILED DESCRIPTION OF THE INVENTION

In accordance with the present invention, it has now been found that encapsulating polyaniline (PANI)/poly-vinyl-pyrrolidine (PVP) and an enzyme, preferably urease, into a biosensor through an electrospinning process yielding a nonwoven mat enhances the activity of the enzyme and the sensitivity of the sensor to gases. The large amount of available surface area obtained by the methods of the present invention provides unusually high sensitivity, improved adsorption rates and quick response time in sensing applications.

Typically there are three polymorphs of PANI: leucoemeraldine (insulating), emeraldine (semi-conducting), and pernigraniline (organic metal) with conductivity ranging from 10⁻¹² Scm⁻¹ to 10² Scm⁻¹ [10]. The primary structure of PANI consists of benzenoid rings with an imine backbone and quinoid rings with an amine (double bonded NH) backbone. The benzenoid rings react to oxidative agents and the quinoid rings react to reducing agents. On exposure to oxidative gases, hydration, or acidic media, the benzenoid rings transform into quinoid [11], this process is reversible. The protonation or deprotonation of PANI is highly dependent on its localized environment. Typically, if it is exposed to an oxidative gas atmosphere, such as NO₂, PANI will become doped and an increase in its conductivity will result. Contrary, for a reducing gas atmosphere (NH₃), PANI is undoped and becomes more resistive. The sensors of the present invention, especially the electrospun sensors, exhibit enhanced properties as further described below.

In electrospinning, the tensile force is generated by the interaction of an applied electric charge carried by the jet rather than by the spindles and reels in conventional spinning. Electrical forces in non-axial directions are also important. By “flow characteristics” (of the polymer solution) is meant the jet formation and jet acceleration of the polymer solution, which exits from the polymer solution introduction device, e.g., the needle tip or glass pipette tip, as well as the directional flow of the jet stream in three-dimensional space. Thus, controlling the flow characteristics can include controlling jet formation, controlling jet acceleration, directing the jet stream to a desired target in three dimensional space, steering the jet stream to different targets during the spinning process or a combination of these.

One embodiment of the present invention is directed to a biosensing material comprising polyaniline (PANI)/poly-vinyl-pyrrolidine (PVP) nanocomposite fibers wherein the polyaniline (PANI)/poly-vinyl-pyrrolidine (PVP) nanocomposite fibers retain activity to gaseous analytes. The biosensing material may further comprise the enzyme urease wherein the urease retains its enzymatic activity. The nanocomposite fibers of the present invention may be deposited onto a conductive material as described below to form non-woven mats.

According to one aspect of the invention, the biosensing material may be prepared by an electrospinning process. In this process a solution comprising PVP/PANI and urease is injected from a small nozzle (preferably 20-22 gauge needles) under the influence of an electric field. Applying the external electrostatic field to a conducting fluid (e.g., a charged semi-dilute polymer solution or a charged polymer melt), a suspended conical droplet is formed, whereby the surface tension of the droplet is in equilibrium with the electric field. The build-up of electrostatic charges on the surface of a liquid droplet induces the formation of a jet, which may be subsequently stretched to form a continuous fiber. Before the jet reaches the collecting screen, the solvent may evaporate or solidify. The fibers may be collected on a conductor surface forming nonwoven mats. High surface areas and relatively small pore size characterize the nonwoven mats.

In one embodiment of the invention, the PANI/PVP/UREASE solution may be produced by adding a PANI/PVP solution with a solution containing urease. The PVP-PANI solution comprises 50% wt./vol. PANI mixed with 5.0×10⁻⁵ M in ethanol. The urease solution contains either 0.02 grams to about 0.10 grams of urease, preferably 0.022 grams, in a buffered solution having a pH of 4.0, or about 0.02 to about 0.10 grams of urease, preferably about 0.026 grams of urease in a buffered solution having a pH of 10, or about 0.10 to about 0.20 grams of urease, preferably about 0.13 grams of urease in a PBS buffer solution having a pH of about 7.3. These solutions can be combined and approximately 1 ml of the solution can be subjected to the electrospinning process described above.

The mixture may be electrospun as soon as it is introduced to room temperature to form a composite. Enzymatic activity as well as gas sensitivity may be tested after the completion of the process and compared to pure enzyme in a buffer solution.

The electrospinning process of the present invention has several advantages including capability of producing fibers in the nanometer diameter range (nanofibers), is driven by electrostatic forces that requires only small amounts of polymer precursors, is a one-step process and does not require further treatment to induce porosity, can produce ID nanostructures of metal oxides (nanowires), and can be used to incorporate biomolecules, such as enzymes, into polymer membranes to produce enhanced activity biosensors.

One particular advantage of electrospinning a PVP-PANI matrix and adding an enzyme is that the electrospun PVP-PANI matrix provides a hospitable environment for biological materials. Enzymes are relatively unstable by nature, it is pertinent to immobilize the enzyme in an environment that will aid in the retention of its structure (stable phase). Due to the hydrophilic nature of PVP enzymes, such as urease, enzymes can be immobilized using the electrospinning technique of the present invention. The electrospun PANI bio-composites of the present invention show enhanced selectivity and sensitivity to ammonia gas produced from urease-urea reactions.

In a preferred embodiment of the present invention, the enzyme used to make the biosensor is urease. Urease has a trimer structure and is composed of alpha, beta, and gamma units. Each of these units makes extensive contacts to form a triangle. A flattened sphere of urease has a diameter of about 110 Å and a height of 60 Å. In addition to the three subunits, two nickel atoms are tightly bound to the overall protein and are about 3.5 Å apart and chelated by amino acids. Urease can be used in such applications as peritoneal dialysis. For example, a subject undergoing peritoneal dialysis may use a biosensor wherein the enzyme, urease, is encapsulated into the biosensor through an electrospinning process yielding a nonwoven mat. This process uses the urease to break down urea in the blood and another step to eliminate the ammonia given off.

In addition, urease may be used in hemodialysis. For example, a subject undergoing hemodialysis may use a biosensor wherein the enzyme, urease, is encapsulated into the biosensor through an electrospinning process yielding a nonwoven mat. This hemodialysis procedure will use the urease to break down urea in the blood and will include another step to eliminate the ammonia given off.

A biosensor containing urease may be used in the production of ammonia or carbon dioxide. Urease acts as a catalyst in the hydrolysis of urea to ammonia and carbon dioxide. Therefore, a biosensing material, wherein urease is encapsulated into the biosensor through an electrospinning process yielding a nonwoven mat, may be deposited on a substance such as a filter, and when a urea containing substance comes in contact with the urease deposited on the substrate, ammonia and/or carbon dioxide is produced.

In addition to the above-mentioned applications, urease containing biosensors of the present invention may be used for treating industrial wastewaters containing urea, wastewater reclamation aboard manned spacecraft, and the analysis of creatinine, arginine, heavy metal ions as well as other pollutants. These processes will use filters and the like containing the biosensing materials of the present invention. Other molecules such as antibodies, antigens, peptides, proteins, DNA, RNA and the like can be used in sensing and processing different materials.

In another aspect of the invention, an artificial kidney is provided comprising a biosensor of the present invention, wherein urease is encapsulated into a biosensor through an electrospinning process yielding a nonwoven mat. The nonwoven mats of the present invention containing composite nanofibers when used in the artificial kidney, are successful in retaining enzyme activity, and produce a large surface area characterized by small pore size that provides improved adsorption rate and response time. In other words, smaller concentrations of urea in the fluid being passed through the artificial kidney can be detected and acted upon using the urease containing biosensor of the present invention.

In still another aspect of the invention, additional or substitute enzymes may be used in the biosensing material. In addition to the urea sensor described above, other sensors are also contemplated, such as a sucrose sensor, maltose sensor, galactose sensor, ethanol sensor, glucose sensor, phenol sensor, catachol sensor, lactic acid sensor, pyruvic acid sensor, uric acid sensor, amino acid sensor, L-glutamine sensor, L-glutamic acid sensor, L-asparagine sensor, L-tyrosine sensor, L-lysine sensor, L-arginine sensor, L-phenylalanine sensor, L-methionine sensor, urea sensor, cholesterol sensor, neutral lipid sensor, phospholipid sensor, monoamine sensor, penicillin sensor, amygdalin sensor, creatinine sensor, phosphate ion sensor, nitrate ion sensor, nitrite ion sensor, sulfate ion sensor, mercury ion sensor, hydrogen peroxide sensor, and mixtures thereof.

In order to illustrate various illustrative embodiments of the present inventions, the following examples are provided.

### EXAMPLE 1

PANI/PVP Composites for NO₂ Sensing

In order to form the composite fibers, Lecuoemeraldine Based Polyaniline (FLUKA-Selectophore®) was mixed with 5.0.10-5 M PVP (Sigma-Aldrich) with an average molecular weight of 1,300,000 in ethanol solution. While the molar concentration of PVP stayed constant, the total contribution of PANI and PVP was 100 in 2 ml of ethanol. The PANI concentration varied between about 20% wt./volume and about 80% wt./volume. The composite was then electrospun onto alumina substrates with gold interdigitated contacts, alumina substrates with heaters deposited by sputtering from a platinum target, and aluminum foil for formation of self-supporting films.

### EXAMPLE 2

Bio-Doped PANI

Solutions consisting of about 50% wt./vol. PANI and about 80% wt./vol. PANI were mixed with 5.0.10-5 M PVP in ethanol. Three solutions of the active enzyme Urease E.C.3.5.1.5 (Sigma-Aldrich 16,000 U/gm) were made and consisted of 0.022 gm urease in buffer solution of pH 4, 0.026 gm urease in buffer solution of pH 10, and 0.13 gm of urease in PBS (Phosphate Buffered Saline) buffer solution (pH 7.3). 1 ml of PVP-PANI solution was mixed with 1 ml of the urease solution for electrospinning onto aluminum substrates.

Electrospinning of the PANI/PVP Solutions.

Electrospinning PANI/PVP solutions will further enhance the dispersion of PANI particles and therefore improve the sensory nature of PANI. The setup is typically operated in air and consists of a DC voltage power supply (Gamma High Voltage Research, Model ES 30P-6W), a programmable syringe pump (KD Scientific, model 200), and an aluminum collector plate. The voltage applied by the power supply is high enough to break to surface tension of droplets of the solution formed at the end of the syringe inducing the formation of a jet. Electrostatic forces between the collector plate and the tip of the needle aid the flow of the fibers from the needle to the collector. Fibers of PVP-PANI and PVP-PANI-Urease are formed using 20 and 22 gauge needles at 15 kV and 20 kV and with flow rates ranging from 5 μl/min-50 μl/min. The distance between the needle and the collector varied between 5-6 mm.

In order to test the biosensors produced, two concentrations of Urea (ACS Reagent, Sigma, EC 200-315-5) were used for analysis: 0.25 M and 0.001 M. Reactivity measurements to Urea were made using a Thermo Orion ammonia electrode. Sensing tests to various gas atmospheres of the PVP-PANI fibers processed above were performed. An applied voltage change in the sample current was measured in wet synthetic air and a constant temperature of 20° C. A flow-through technique was used for sensing experiments in which the synthetic air was the carrier gas for NO₂. Results from sensor exposure to NO₂ concentrations ranging from 1 ppm to 7 ppm were observed.

Scanning Electron Microscopy (SEM) characterization was conducted using a LEO-1550 FEG SEM. A high tension of 15 kV was used and the samples were sputter coated with gold prior to analysis.

### Results and Discussion

NO₂ Sensing Experiments.

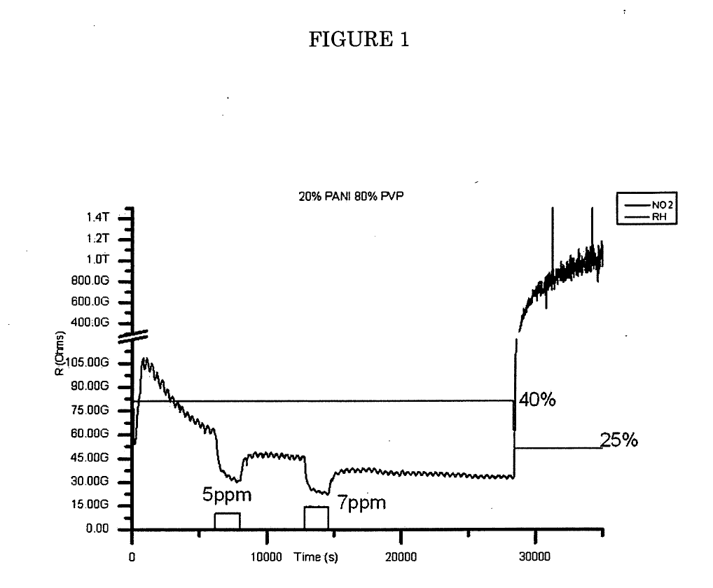

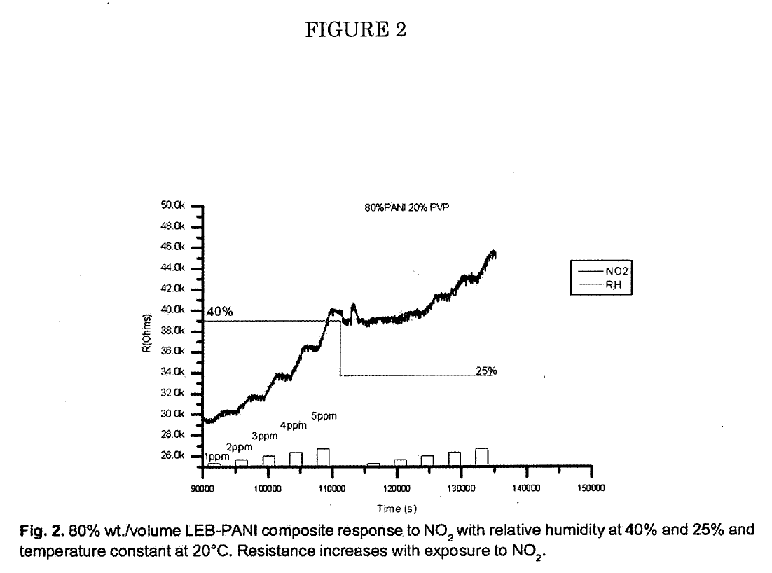

The PVP/PANI composites were initially exposed to several vapors, of which only responses to NO₂ are discussed here. The results suggest that even with the base form of polyaniline, LEB-PANI, an increase in the matrix conductivity in the presence of low concentrations of NO₂ (1-7 ppm) was measured. However the response to NO₂ in the presence of relative humidity (25% and 40%) for 20% wt./vol. and 80% wt./vol. PANI concentrations are shown most substantial and thus results for these sensing experiments will be further discussed (FIGS. 1 and 2). The amplitude of the response however is an order of magnitude higher in the 20% wt./vol. PANI sample than in the 80% wt./vol. PANI sample. This can also be described by analysis of the coatings sensitivity to 5 ppm of NO₂.

The equation for relative sensitivity is given by:
S=|ΔR|Rₒ*100
where ΔR is the change in resistance on exposure to gas analyate and Rₒ is the initial measured resistance value (before exposure). For exposures of 5 ppm of NO₂ the relative sensitivity for the 20% wt./vol. PANI sample is 45% and for the 80% wt./vol. PAM sample S=9.5%.

During exposure NO₂ oxidizes PANI, which typically results in an increase in the conductivity of PANI. PANI concentrations tested in these experiments ranged from 50%-80% and 20% wt./vol. Ghosh et al. [18] showed an increase in doped PANI conductivity with increasing wt. % concentration in PVP, however the present our analysis show that at high concentrations and in the presence of NO₂ the conductivity of PANI actually reduces and an opposite reaction is observed. The reverse reaction seems to take place at concentrations above 50% wt./vol. PANI in the PVP-PANI solution.

FIGS. 1 and 2 illustrate the effects of NO₂ and relative humidity on 20% wt./vol. PANI and 80% wt./vol. PANI. It has been observed that there may be internal redox reactions occurring within the high concentration PANI composites due to the processing of these films in air. At high concentrations, the PANI film is more susceptible to environmental doping or oxidation from air, this is evident in FIG. 2 where the conductivity of the 80% wt./vol. PANI film is on the order of 10³ Ohms compared to the conductivity of the 20% wt./vol. PANI film (10⁹ Ohms).

Effects of Humidity of the Biosensors.

The charge transfer mechanism between the water vapor and PANI competes with doping or de-doping mechanisms from redox reactions. In the presence of increasing humidity the materials reaction to NO₂ decreases (as confirmed in the literature [6,8]). However, it appears the material's sensing mechanism only initiates in the presence of the water vapor (FIG. 2). Typically on exposure to water vapor, PANI becomes protonated, and an increase in conductivity can be observed.

Many authors have also detailed the effects of water vapor on the PANI conduction mechanism. Understanding the effects of humidity or hydration on the sensing mechanism is necessary for environmental monitoring applications. It has been shown that water assists protons in conduction by creating pathways for charge hopping between PANI grains. The reactions between water and PANI can be explained in several ways: (1) PANI particles increase in size with water adsorption on the surface [7], (2) grain boundary barriers break down with exposure to water vapor [6], (3) there is an exchange of protons between the water vapor and the PANI particles [19], or (4) water causes an acid-base transition in PANI-PVP composite.

In the electrospun matrix, the PVP fibers allow for increased flow of water vapor to the PANI aggregates. PVP is a hydrophilic polymer and researchers have shown that the water molecules bond to carbonyl and C-N sites. of the polymer [20]. Due to the nature of the interactions between PVP and the water molecules, it is predicted that a percentage of the water vapor will remain trapped in the PVP/PANI matrix, unless the system is subjected to elevated temperatures. While in the system, the water attaches itself to both the amine and imine centers of the quinoid and benzenoid structural units. The amine acts as proton acceptor while the imine center acts as proton donor [6]. The trapped water may cause swelling of the PANI particulates or direct protonation with the exchange of protons from water molecules [6].

Bio-Doped PANI.

Results from the reactivity measurements for the three samples confirm that the urease retains its activity in the electrospun composite matrix. For solutions of higher pH (pH 10), the change in potential measured by the ammonia electrode was 0.8 mV. However for solutions of low pH (pH 4), the change in potential was an order of magnitude higher.

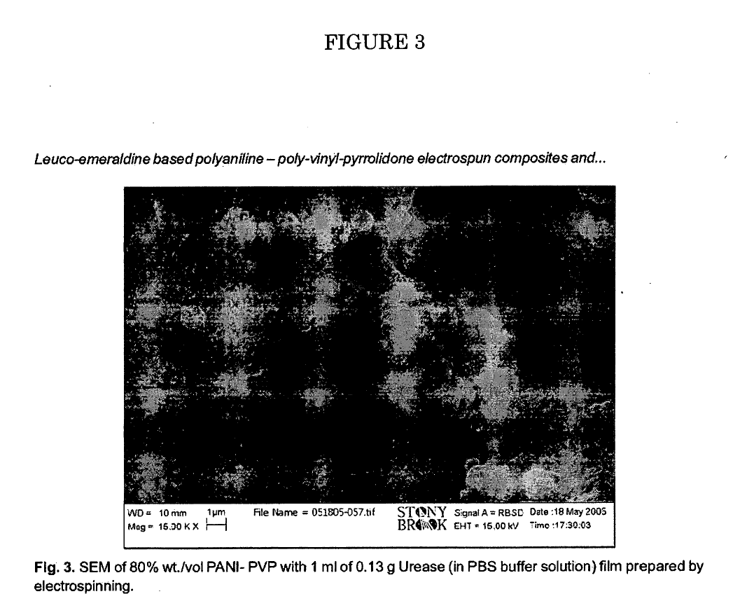

SEM characterization (FIG. 3) suggests that the urease attaches to the surface of the PANI aggregates formed during the electrospinning process. As FIG. 3 will show the urease self assembles on the surface of PANI aggregates in a distinctive pattern. It is predicted that due to the immobilization of urease in the PANI-PVP matrix there will be an increase in the film's sensitivity to ammonia. Moreover, due to the nature the electron charge transfer properties of PANI, the reactivity of urease in urea solution should also increase. Further analysis is necessary to determine whether there are chemical bonds forming between PANI and the enzyme and what ion exchange processes occur between the two materials.

Therefore, based on the foregoing, it is understood that the biosensors of the present invention are an active matrix with a high surface to volume ratio providing sensitive robust membranes tunable for multi-functional sensor technologies or for systems that require protective coatings (i.e. protective textiles, armament systems, etc.,), as well as a suitable environment for the immobilization of biological receptors. Bio-doped PANI composites may also play a multi-faceted role in biological sensing: increasing reactivity of the bio-receptor and enhancing sensitivity of the PANI composite to the target analyte. Although there has been much focus on the use of PANI as a sensing membrane, the spotlight has been on the use of emeraldine based or pernigraniline (emeraldine salt). LEB-PANI has not been well studied for its effectiveness as a sensing mechanism for NOx and environmental monitoring.

As discussed above, the responsive nature of polyaniline (PANI) to gaseous pollutants is highly dependant on the film composition and processing. According to one aspect of the present invention, the LEB-PANI/PVP containing material developed to be used as a room temperature sensor for NO₂ detection, has a relative response to NO₂ in constant humidity and is directly dependant on the concentration of polyaniline in electrospun films of PANI and poly-vinyl-pyrrolidone (PVP). In summary, the overall effectiveness of the sensors of the present invention is enhanced by virtue of the PANI/PVP/urease composition being electrospun according to the process of the present invention.

While the present invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

### REFERENCES

[1] S. Christie, E. Scorsone, K. Persaud and F. Kvasnik//H Sens. Actuators B 90 (2003) 163.
[2] J. Huang, S. Virji, B. Weiler and R. Kaner//J. Am. Chem. Soc. 125 (2003) 314.
[3] M. Gerard, A. Chaubey and B. D. Malhotra//Biosensors and Bioelectronics 17 (2003) 345.
[4] V. N. Prigodin and A. J. Epstein//Synthetic Metals 125 (2002) 43
[5] D. Chinn, J. DuBow and M. Liess//Chem. Mater. 7 (1995) 1504.
[6] E. S. Matveeva//Synthetic Metals 79 (1996) 127.
[7] E. Tobolkova, J. Prokes, I. Krivka, M. Trchova and J. Stejskal//Macromol. Symp. 212 (2004) 447.
[8] J. Elizade-Torres, H. Hu and A. Garcia-Valenzuela//Sens. Actuators B 98 (2004) 218.
[9] A. Kukla, Y. Shirshov and S. Piletsky//Sensors and Actuators B 37 (1996) 135.
[10] M. Campos and B. Bello//J. Phys. D: Appl. Phys 30 (1997) 1531.
[11] J. Sariciftci and H. Kuzmany//J. Chem. Phys. 7 (1990) 92. 6 A. Bishop and P. Gouma
[12] C. K. Subramaniam, A. B. Kaiser, P. W. Gilberd, C. Liu and B. Wessling//Sol. State Comm. 97 (1996) 235.
[13] J. Stejskal, P. Kratochvil and M. Helmstedt//Langmuir 12 (1996) 3389.
[14] R. Murugesan, G. Anitha and E. Subramanian//Materials Chemistry and Physics 85 (204) 184.
[15] P. Somani//Materials Chemistry and Physics 77 (2002) 81.
[16] K. M. Sawicka, P. Gouma and S. Simon//Sensors Act. B (2005), in print.
[17] J. Langer, M. Filipiak, J. Kecinska, J. Jasnowska, J. Wlodarczak and B. Buladowski//Surface Science 573 (2004)140.
[18] P. Ghosh, S. Siddhanta and A. Chakrabarti//European Polymer Journal 35 (1999) 699.
[19] K. Ogura, A. Fujii, H. Shiigi, M. Nakayama and T. Tonosaki//Journal of The Electrochemical Society 147 (2000) 1105.
[20] N. Shinyashiki, Y. Masumura, N. Miura, S. Yagihara and S. Mashimo//J. Phys. Chem. 98 (1994) 13612.

What is claimed is:

1. A biosensing material comprising polyaniline (PANI)/poly-vinyl-pyrrolidine (PVP) nanocomposite fibers wherein the polyaniline (PANI)/poly-vinyl-pyrrolidine (PVP) nanocomposite fibers retain activity to gaseous analytes.

2. The biosensing material of claim 1 further comprising urease wherein the urease retains enzymatic activity.

3. The biosensing material of claim 1 produced by an electrospinning process.

4. The biosensing material of any of claim 1 wherein the polyaniline (PANI)/poly-vinyl-pyrrolidine (PVP) nanocomposite fibers are deposited onto a conductive material.

5. The biosensing material of claim 4 wherein said conductive material is selected from the group consisting of alumina substrates having gold interdigitated contacts, alumina substrates having heaters deposited thereon, aluminum foil and mixtures thereof.

6. The biosensing material of claim 5 wherein said alumina substrates having heaters deposited thereon is deposited by sputtering from a platinum target.

7. The biosensing material of claim 1 wherein the polyaniline (PANI) is selected from the polymorph group consisting of leucoemeraldine (Leuco-Emeraldine), ermeraldine, pernigraniline and mixtures thereof.

8. A method of producing a biosensor material of claim 2 comprising:
injecting a solution that comprises polyaniline (PANI)/poly-vinyl-pyrrolidine (PVP) and urease under the influence of an electric field wherein the build-up of electrostatic charges on a surface of a liquid droplet of said solution induces formation of a jet;
stretching said induced jet formed by said build-up of electrostatic charges on said surface of said liquid droplet of said solution to form at least one continuous fiber; and
collecting said at least one continuous fiber on a conductor surface to form a film wherein the polyaniline (PANI) retains its activity to gaseous analytes, said urease enzyme retains its activity towards urea, and said film has a high surface area with a relatively small pore size.

9. The method of claim 8 wherein the solution that comprises polyaniline (PANI)/poly-vinyl-pyrrolidine (PVP) and urease is produced prior to injecting said solution under the influence of the electric field and comprises about 1 ml of polyaniline (PANI)/poly-vinyl-pyrrolidine (PVP) solution mixed with about 1 ml of urease solution.

10. The method of claim 9 wherein the polyaniline (PANI)/poly-vinyl-pyrrolidine (PVP) solution comprises about 50% wt./vol. of polyaniline (PANI) mixed with about 5.0×10⁻⁵ M in ethanol and said urease solution is selected from a group of solutions consisting of about 0.02 grams to about 0.10 grams of urease in a buffered solution having a pH of about 4.0, about 0.02 grams to about 0.10 grams of urease in buffered solution having a pH of about 10, and about 0.10 to about 0.20 grams of urease in a PBS buffered solution having a pH of about 7.3.

11. A method of peritoneal dialysis wherein a subject undergoes dialysis using a dialysis system comprising at least one biosensing material of claim 4.

12. A method of hemodialysis wherein a subject undergoes dialysis using a dialysis system comprising at least one biosensing material of claim 4.

13. A method of removal of urea from alcoholic beverages wherein said alcoholic beverage is applied to said biosensing material of claim 4 and said alcoholic beverage reacts with said urease of said biosensing material to form ammonia and carbon dioxide.

14. A method of analyzing urea concentration in a solution using the biosensing material of claim 4 comprising reacting said solution containing urea with said biosensing material to produce ammonia.

15. A method of producing ammonia wherein urea is applied to said biosensing material of claim 4 to react with said urease of said biosensing material to form ammonia.

16. A method of producing carbon dioxide comprising applying urea to said biosensing material of claim 4 so as to allow said urea to react with said urease of said biosensing material to form carbon dioxide.

17. A method of treating wastewater comprising contacting wastewater containing urea with said biosensing material of claim 4 so as to allow said urea to react with said urease to said biosensing material to form ammonia.

18. The method of claim 17 wherein said ammonia produced is removed from said wastewater.

19. A method of treating wet vapor comprising:
passing said wet vapor through a catalytic converter comprising said biosensing material of claim 4;
reacting said wet vapor s with said urease of said biosensing material to form carbon dioxide, NO₂ or both; and
measuring the concentration of NO₂.

20. The biosensing material of claim 2 comprising either in addition to or instead of urease at least one enzyme reactive to a substance selected from the group consisting of sucrose, maltose, galactose, ethanol, glucose, phenol, catachol, lactic acid, pyruvic acid, uric acid, amino acid, L-glutamine, L-glutamic acid, L-asparagine, L-tyrosine, L-lysine, L-arginine, L-phenylalanine, L-methionine, cholesterol, neutral lipid, phospholipid, monoamine, penicillin, amygdalin, creatinine, phosphate ion, nitrate ion, nitrite ion, sulfate ion, mercury ion, hydrogen peroxide and mixtures thereof.
